(19) United States
(12) Patent Application Publication
(10) Pub. No.: US 2025/0345933 A1
(43) Pub. Date: Nov. 13, 2025

(54) EXPECTED HUMAN TRAJECTORY GENERATION FOR TELEOPERATION

(71) Applicant: Honda Motor Co., Ltd., Tokyo (JP)

(72) Inventors: Songpo LI, San Jose, CA (US); Anshul A. NAYAK, Blacksburg, VA (US); Prakash BASKARAN, San Jose, CA (US)

(21) Appl. No.: 19/083,337

(22) Filed: Mar. 18, 2025

Related U.S. Application Data
(60) Provisional application No. 63/645,738, filed on May 10, 2024.

(51) Int. Cl. B25J 9/16

(52) U.S. Cl. CPC B25J 9/163; B25J 9/1605; B25J 9/1689; G05B 2219/39001

(57) ABSTRACT

According to one aspect, expected human trajectory generation for teleoperation may include generating a movement cost associated with movement of a robot appendage from a first state including a start position and a start pose to a second state including a goal position and a goal pose, generating a joint cost associated with movement of joints of the robot appendage from the first state to the second state, generating a smoothness cost associated with a velocity associated with movement of the robot appendage from the first state to the second state, generating an expected human trajectory based on the movement cost, the joint cost, and the smoothness cost, and controlling an actuator to move the robot appendage based on the expected human trajectory and an input from a human operator.

### CROSS-REFERENCE TO RELATED APPLICATIONS

This application claims the benefit of U.S. Provisional Patent Application, Ser. No. 63/645,738 (Attorney Docket No. HRA-56024) entitled “HUMAN SENSE OF AGENCY DURING TELEOPERATION”, filed on May 10, 2024; the entirety of the above-noted application(s) is incorporated by reference herein.

### BACKGROUND

Sense of Agency (SoA) may be achieved when a human feels in control of a task during teleoperation. SoA may be affected when there is discrepancy between an intended command and an actual command. Factors which may influence SoA may include when a human lacks an ability to reliably estimate an own hand position in space and time in virtual reality (VR), even though the human feels the task is completed, the robot fails to complete task, movement ratios between the VR environment and the real-world environment are out of balance, lag or large time delays between actual commands and execution, etc.

### BRIEF DESCRIPTION

According to one aspect, a system for expected human trajectory generation for teleoperation may include a processor and a memory. The memory may store one or more instructions. The processor may execute one or more of the instructions stored on the memory to perform one or more acts, actions, and/or steps, such as generating a movement cost associated with movement of a robot appendage from a first state including a start position and a start pose to a second state including a goal position and a goal pose, generating a joint cost associated with movement of joints of the robot appendage from the first state to the second state, generating a smoothness cost associated with a velocity associated with movement of the robot appendage from the first state to the second state, and generating an expected human trajectory based on the movement cost, the joint cost, and the smoothness cost.

The system for expected human trajectory generation for teleoperation may include a control interface receiving an input from a human operator, a controller, and an actuator. The controller may control the actuator to move the robot appendage based on the expected human trajectory and the input from the human operator. The controller may control the actuator to move the robot appendage based on minimizing an offset between the expected human trajectory and a trajectory associated with the input from the human operator. The movement cost, the joint cost, and the smoothness cost may be generated without using sensor feedback information from sensors associated with the robot appendage. The movement cost, the joint cost, and the smoothness cost may be generated without using information indicative of a task or context associated with the first state, the start position, the start pose, the second state, the goal position, and the goal pose. The movement cost or the joint cost may be generated based on a human arm skeletal model. The human arm skeletal model may have seven degrees of freedom (DoF). The processor may generate a jerk cost associated with an acceleration associated with movement of the robot appendage from the first state to the second state. The processor may generate the expected human trajectory based on the jerk cost. The processor may generate the expected human trajectory based on model predictive control (MPC).

According to one aspect, a computer-implemented method for expected human trajectory generation for teleoperation may include generating a movement cost associated with movement of a robot appendage from a first state including a start position and a start pose to a second state including a goal position and a goal pose, generating a joint cost associated with movement of joints of the robot appendage from the first state to the second state, generating a smoothness cost associated with a velocity associated with movement of the robot appendage from the first state to the second state, and generating an expected human trajectory based on the movement cost, the joint cost, and the smoothness cost.

The computer-implemented method for expected human trajectory generation for teleoperation may include receiving an input from a human operator and controlling an actuator to move the robot appendage based on the expected human trajectory and the input from the human operator or controlling the actuator to move the robot appendage based on minimizing an offset between the expected human trajectory and a trajectory associated with the input from the human operator. The movement cost, the joint cost, and the smoothness cost may be generated without using sensor feedback information from sensors associated with the robot appendage. The movement cost, the joint cost, and the smoothness cost may be generated without using information indicative of a task or context associated with the first state, the start position, the start pose, the second state, the goal position, and the goal pose.

According to one aspect, a system for expected human trajectory generation for teleoperation may include a control interface receiving an input from a human operator, an actuator, a memory storing one or more instructions, and a processor executing one or more of the instructions stored on the memory to perform one or more acts, actions, and/or steps. For example, the processor may generate a movement cost associated with movement of a robot appendage from a first state including a start position and a start pose to a second state including a goal position and a goal pose, generate a joint cost associated with movement of joints of the robot appendage from the first state to the second state, generate a smoothness cost associated with a velocity associated with movement of the robot appendage from the first state to the second state, and generate an expected human trajectory based on the movement cost, the joint cost, and the smoothness cost. The system for expected human trajectory generation for teleoperation may include a controller controlling the actuator to move the robot appendage based on the expected human trajectory and the input from the human operator.

The controller may control the actuator to move the robot appendage based on minimizing an offset between the expected human trajectory and a trajectory associated with the input from the human operator. The movement cost, the joint cost, and the smoothness cost may be generated without using sensor feedback information from sensors associated with the robot appendage. The movement cost, the joint cost, and the smoothness cost may be generated without using information indicative of a task or context associated with the first state, the start position, the start pose, the second state, the goal position, and the goal pose. The movement cost or the joint cost may be generated based on a human arm skeletal model.

### BRIEF DESCRIPTION OF THE DRAWINGS

FIG. 1 is an exemplary system for expected human trajectory generation for teleoperation, according to one aspect.

FIG. 2 is an exemplary computer-implemented method for expected human trajectory generation for teleoperation, according to one aspect.

FIG. 3 is an exemplary scenario where an expected human trajectory associated with teleoperation is generated according to the system and method for expected human trajectory generation for teleoperation of FIGS. 1-2, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

In shared teleoperation, a robot may closely follow a human's input or command. However, lack of reliable estimation of position in the virtual environment may cause discrepancy between an intended action and an actual action the human performs (e.g., the input). For example, in robotic teleoperation, when the robot's behavior does not match the operators' expectations, the sense of agency decreases. In such scenarios, the human may lose a sense of control or sense of agency (SoA) over the robot. This is because the mismatching behavior between the robot and the human may make the operators feel as if they are not the author of the motion or they are not in control of the robot's behavior. For example, if the motion is laggy or there is unexpected motion scaling, the human may lose their SoA. Further, when the robot actively assists the operator for task completion by generating autonomous behaviors (e.g., not derived from the human), this may further decrease the operator's SoA. Ideally, a robot's behavior might match the operator's intended behavior, when possible. This may result in an increase in a cognitive load and may undesirably require additional human effort. The present disclosure may thus address the problem of how the robot may adapt to a human's expectation such that the human feels in control of the robot and has SoA.

Multiple factors may influence SoA. One factor may be the human's intended or expected path. Thus, of the multiple paths that the robot may take to complete a task, having prior knowledge about human's intended path may help the robot plan its own trajectory, ensuring SoA. A model of the human arm may be designed and utilized as a model-based optimization approach for generating human-like motion. Different objectives may be minimized, such as smoothness, task completion, total effort, etc. to ensure human likeness. In this way, the human motion generation may ensure SoA.

While feedback, such as visual feedback or haptic feedback has been implemented, these approaches are generally geared toward forcing the human to approach the task in a way that caters to the robot, rather than the other way around. For example, a robot feasible trajectory may be provided as a visual cue for the human to follow. As another example, force feedback may be provided to guide the human hand. However, both of these examples may result in an undesirable loss of SoA for the human. Further, data driven approaches may utilize large datasets or a large amount of processing power.

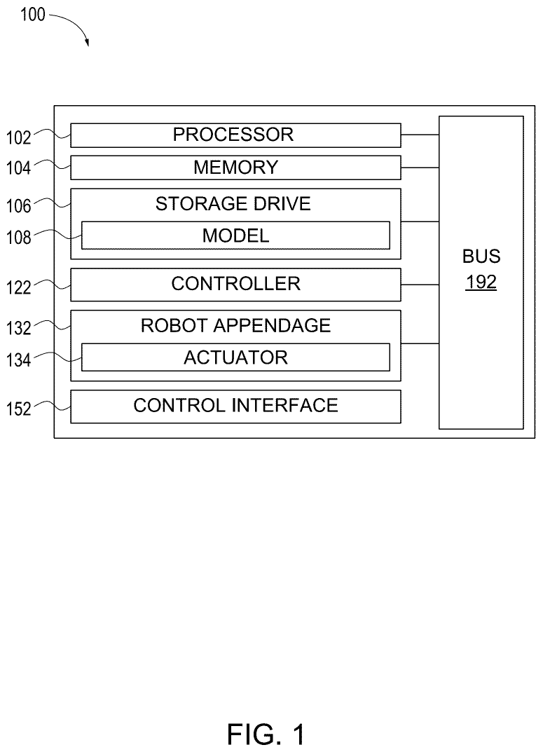

FIG. 1 is an exemplary system 100 for expected human trajectory generation for teleoperation, according to one aspect. The system 100 for expected human trajectory generation for teleoperation may be a robot (herein ‘the robot’), according to one aspect. The system 100 for expected human trajectory generation for teleoperation (or robot) may include a processor 102, a memory 104, a storage drive 106, a controller 122, a robot appendage 132 including an actuator 134, a control interface 152, and a bus 192. The storage drive 106 may store a human arm skeletal model 108 generated by or in association with the system 100 for expected human trajectory generation for teleoperation. The bus 192 may communicatively couple or operably couple one or more respective components (e.g., the processor 102, the memory 104, the storage drive 106, the controller 122, the robot appendage 132, the control interface 152, etc.) and enable computer communication therebetween.

The memory 104 may store one or more instructions. The processor 102 may execute one or more of the instructions stored on the memory 104 to perform one or more acts, actions, and/or steps. The storage drive 106 may store one or more models 108 in connection with the expected human trajectory generation for teleoperation, such as the human skeletal model or the human arm skeletal model. For example, the human skeletal model or the human arm skeletal model may have multiple degrees of freedom (DoF) (e.g., four DoF, seven DoF, etc.).

During shared teleoperation, an operator or human may remotely control a robot. The control interface 152 may be implemented on a mobile device or on-board the system 100 for expected human trajectory generation for teleoperation, and may receive an input (e.g., a command) from a human operator in association with the expected human trajectory generation for teleoperation. The robot may consider the command of the operator to complete a task. However, there may arise discrepancy between what the human intends to achieve and the actual action that the human performs. Especially in shared teleoperation, humans may lack a sense of space and time in virtual world when trying to control a robot through teleoperation. Often in such scenarios, the human cannot reliably estimate their own hand position. Even though the human feels like the human has completed the task in the virtual world, the robot in reality fails to complete the task.

The human then may choose a different path than what may be actually intended to complete the task. Such scenarios increase the mental effort expended on human which the human might associate with a feeling of losing control over the robot as the robot may be unable to match human's expectations. This may be primarily what a loss of SoA implies in shared teleoperation when the human's intended action does not match the actual outcome. Other factors may affect the SoA, such as spatial and temporal lag. For example, the robot usually follows the human's command and if the temporal lag is high between the actual human intention and robot motion, the human will lose a sense of control over the robot. In this regard, the subject matter of the present disclosure enables completion a task such that the human feels in control of the robot.

The processor 102 may capture a human's intention by estimating the expected path the human might take, such that the robot may adapt its own trajectory based on human's expected path so that the human feels in control of the task without additional cognitive load.

For shared teleoperation, data driven methods may not be user specific as a trajectory generated by one individual may vary for another individual with a different limb length. To address these issues, a model-based optimization to synthesize human like upper limb motion which has the advantage of being task-agnostic and also personalized to the individual is discussed herein. In other words, according to one aspect, the model or the model-based optimization may predict the operator's intended behavior (e.g., as a trajectory) which may be taken as the expected behavior for the robot. Instead of using data-driven models to predict the operator's behavior (e.g., motion trajectory), a human skeletal model may be utilized to predict the operator's behavior (e.g., motion trajectory). One advantage is that this does not rely on a large amount of data and is easier to personalize for individual operators. Another advantage is that this may better or more accurately represent the human natural behaviors rather than the constrained behaviors in the teleoperation setting.

Upper limb biological movement synthesis may be useful to understand the intention of human in the future. Imitating human-like behavior may be challenging as there may be infinitely many possible paths and velocity profiles that a human may take to reach a target. Generating human arm like reaching motion may include considering the minimum jerk principle to generate trajectories. However, human behavior generally does not rely on one single objective to generate motion. Humans may generate trajectories based on some optimality criteria pertaining to the task at hand. The motion generation described herein may be formulated as an optimal control problem where the model continually optimizes the behavior performance.

For example, the processor 102 may formulate the problem as a closed loop optimization problem where multiple criteria are added as a cost to an objective function based on the task. Details of the formulation are described in greater detail herein. Human arm models, such as planar or 4 DoF arm models coupled with the cost functions or factors in the objective function may be utilized by the processor 102 to synthesize non-linear biological movements. This may be implemented as a kinodynamic planning based on an approximate model of the system where the motion is generated by minimizing the objective function. Additionally, single cost functions such as a minimum torque change function, a minimum angular jerk function, a minimum variance function, or a weighted combination of these cost functions may be used to synthesize the motion or the expected human trajectory.

In this regard, the input may be a teleoperation command, for example, commanding the robot appendage 132 to transition from a first state to a second state. According to one aspect, the first state may include a start position (e.g., first position) and a start pose (e.g., first pose) and the second state may include a goal position (e.g., second position) and a goal pose (e.g., second pose). The processor 102 may generate the expected human trajectory based on model predictive control (MPC).

According to one aspect, the processor 102 may utilize a 7 DoF high-fidelity upper limb model of a human to generate a realistic motion from the start pose in a special Euclidean group, SE(3) to the goal pose. The optimization may be implemented as a closed loop model predictive control (MPC) problem by the processor 102, where the model predicts the future motion over a fixed time horizon and optimizes the objective to synthesize human like motion as the expected human trajectory, which may include position, velocity, acceleration, etc. from the first state to the second state.

### Human Arm Skeletal Model

According to one aspect, the processor 102 may formulate the 7 DoF as a human arm skeletal model with 7 joints and 3 links. The 3 links may represent the shoulder, forearm, and hand, while the joints (e.g., the spherical joint in shoulder) may be modelled as 3 revolute joints for adduction, flexion-extension, and pronation-supination movements. Similarly, the elbow and wrist may be each modeled using 2 revolute joints, respectively. Using the Denavit Hartenberg (DH) convention, the processor 102 may build the kinematic model for the human arm accordingly.

The formulation of human arm skeletal model for motion generation as the 7 DoF multi-body dynamics model using optimal control for reach to grasp motion in SE(3) may be generated by the processor 102 as follows:

$${A}_{i} = {R}_{z , {q}_{i}} {Trans}_{z , {d}_{i}} {Trans}_{x {α}_{i}} {R}_{x , {α}_{i}} \qquad ( 1 )$$

$$= [ \begin{matrix}{c}_{{θ}_{i}} & - {s}_{{θ}_{i}} {c}_{{α}_{i}} & {s}_{{θ}_{i}} {s}_{{α}_{i}} & {a}_{i} {c}_{{θ}_{i}} \\ {s}_{{θ}_{i}} & {c}_{{θ}_{i}} {c}_{{α}_{i}} & - {c}_{{θ}_{i}} {s}_{{α}_{i}} & {a}_{i} {s}_{{θ}_{i}} \\ 0 & {s}_{{α}_{i}} & {c}_{{α}_{i}} & {d}_{i} \\ 0 & 0 & 0 & 1\end{matrix} ] \qquad ( 2 )$$

The forward kinematics describing the end effector pose for the hand may be calculated by the processor 102 as a series of transformations from base frame to end-effector T₇⁰=A₁A₂A₃A₄A₅A₆A₇. The transformation T₇⁰∈SE(3) may represent the rotation R∈ [symbol] and translation T∈ [symbol] . Although the kinematic model may be utilized to estimate pose in Cartesian space, it lacks dynamic properties to model the human arm for realistic motion generation. Therefore, dynamic properties such as mass, inertia, length and center of mass (COM) of the links may be provided to create an approximate dynamics model of the human arm. For a link associated with a joint, an inertia tensor I∈R^{3×3} may be symmetric with principal moments having non-zero values. According to one aspect, dynamic properties associated with inertial parameters of human upper limb segments may be provided.

The forward dynamics of the human arm skeletal model may be estimated by the processor 102 using Featherstone's rigid body dynamics model:

$$τ = M ( q ) \ddot{q} + C ( q , \dot{q} ) \dot{q} + G ( q ) \qquad ( 3 )$$

$$\ddot{q} = {M}^{- 1} ( τ - C ( q , \dot{q} ) \dot{q} - G ( q ) )$$

Here, M(q)∈ [symbol] , C(q, \dot{q})∈ [symbol] , and G(q)∈ [symbol] may represent inertia, Coriolis, and gravity terms, respectively. \ddot{q} may represent a forward dynamics of the human arm. The human arm skeletal model may be validated under gravitational load without any external torque. Thereafter, human-like motion may be generated with the validated model using optimal control.

### Optimal Control for Motion or Trajectory Generation

Consider a discrete time nonlinear dynamic system with state variable xₖ∈ [symbol] and control uₖ∈ [symbol] .

$${x}_{k + 1} = f ( {x}_{k} , {u}_{k} ) \qquad ( 4 )$$

where x=[q, \dot{q}]^{T} may represent the joint angles and joint velocities, respectively and q=[q₁, q₂, . . . q₇]^{T} may represent the 7 joints of the human arm skeletal model. Similarly, u=[τ₁, τ₂, . . . τ₇,]^{T} represent the joint torques. The processor 102 may formulate the problem as a multi-objective constrained optimization with the dynamics model in order to achieve human-like motion. The cost function for simultaneous reaching and orientation may be formulated by the processor 102 as:

$$J = Control Effort + Rotational Cost + Translational Cost + Velocity + Joint Angle Cost + Joint Velocity Cost + Minimum Jerk \qquad ( 5 )$$

$$Control Effort = {ω}_{1} {\sum }_{0}^{T} {u ( t )}^{⊤} u ( t )$$

$$Rotational Cost = {ω}_{2} ‖ ( I - {R}_{g}^{⊤} {R}_{e p} ) ‖$$

$$Translational Cost = {ω}_{3} ‖ p ( T ) - {p}^{*} ‖$$

$$Velocity = {ω}_{4} ‖ {\dot{p} ( T )}^{2} ‖$$

$$Joint Angle Cost = {ω}_{5} ‖ q - {q}^{*} ‖$$

$$Joint Velocity Cost = {ω}_{6} ‖ \dot{q} - {\dot{q}}^{*} ‖$$

$$Minimum Jerk = {ω}_{7} ‖ \ddot{q} ‖$$

The processor 102 may generate a movement cost associated with movement of a robot appendage 132 from a first state to a second state. The processor 102 may generate a joint cost associated with movement of joints of the robot appendage 132 from the first state to the second state. The movement cost and/or the joint cost may represent a minimization of effort, as humans typically utilize energy optimal trajectories in line with joint or movement constraints, for example. The processor 102 may generate a smoothness cost associated with a velocity associated with movement of the robot appendage 132 from the first state to the second state. The smoothness cost may represent a goal or desire to have a start velocity (e.g., associated with the first state) and an end velocity (e.g., associated with the second state) be zero or a near zero value. The processor 102 may generate a jerk cost associated with an acceleration associated with movement of the robot appendage 132 from the first state to the second state. The jerk costs may represent a goal or desire to have a minimum amount of jerk.

The task may be to start from an initial hand pose T and reach a goal pose T_{g}∈SE(3). Here, R_{g}^{I} and Rₑₚ may represent a rotation matrix for the goal pose and the hand pose, respectively. p(T) and \dot{p} may represent the position and the velocity of an end-effector of hand in Cartesian coordinates. p* may represent the desired goal position of the hand. q and \dot{q} may represent the joint angles and the joint velocity of the arm at any time T while q* and \dot{q}* may represent the desired joint states. Finally, to achieve smoothness and prevent sudden acceleration during motion, jerk may be minimized. ω₁, ω₂, . . . ω₇ may represent the relative weights associated with cost factors which may be tuned to minimize the cost function.

Apart from the formulation of the objective function, constraints on states and control may be implemented by the processor 102 to ensure the generated torque and states do not exceed the predetermined limits. For human-like motion generation, the limits on joint states and joint torques may be set based on average daily tasks performed by humans. In this way, the optimization converges to the goal pose and a predicted path capturing the human's expectation.

The processor 102 may generate an expected human trajectory based on the movement cost, the joint cost, the smoothness cost, and the jerk cost. Additionally, the movement cost or the joint cost may be generated based on the human skeletal model or the human arm skeletal model.

The expected human trajectory may facilitate a robot trajectory of the robot appendage 132 aligning with a trajectory associated with the input (e.g., teleoperation command) from the human operator.

One or more advantages or benefits of the system 100 for expected human trajectory generation for teleoperation and the computer-implemented method 200 for expected human trajectory generation for teleoperation is that the movement cost, the joint cost, and the smoothness cost may be generated without using sensor feedback information from sensors associated with the robot appendage 132, thereby reducing implementation costs and processing time associated with using extra sensors. Further, the movement cost, the joint cost, and the smoothness cost may be generated without using information indicative of a task or context associated with the first state, the start position, the start pose, the second state, the goal position, and the goal pose, thereby reducing the amount of information needed to generate an accurate expected human trajectory. Additionally, human skeletal models may be personalized to users or individuals.

The controller 122 may control the actuator 134 to move the robot appendage 132 based on the expected human trajectory and the input from the human operator. For example, the controller 122 may control the actuator 134 to move the robot appendage 132 based on achievement of the second state, the goal pose, or the goal position, singularity avoidance, feasibility of candidate trajectories, minimizing an offset between the expected human trajectory and a trajectory associated with the input from the human operator (e.g., from a positional profile, from a velocity profile, from an acceleration profile, from a curvature profile, etc.).

In other words, according to one aspect, the controller 122 may adjust the predicted behavior by minimizing the observable difference with consideration of the agency. Although it may be desired to have the robot realize the predicted behavior or fully replicate the predicted behavior, this may not be possible in every scenario. For example, full implementation may not be feasible when an obstacle in the path or singularity of the robotic arm. Thus, the controller 122 may adjust the intended behavior to be feasible for the robot. In the adjustment, the controller 122 may attempt to minimize observable discrepancies between the robotic behavior and the operator's intended behavior rather than minimizing the adjustment from the original behavior. There are many ways to adjust the predicted behavior, and some of the discrepancies may be easily observed or sensed by the operator. In this regard, the controller 122 may select adjustments which mask the discrepancies, and thus, less likely to be sensed by the operator.

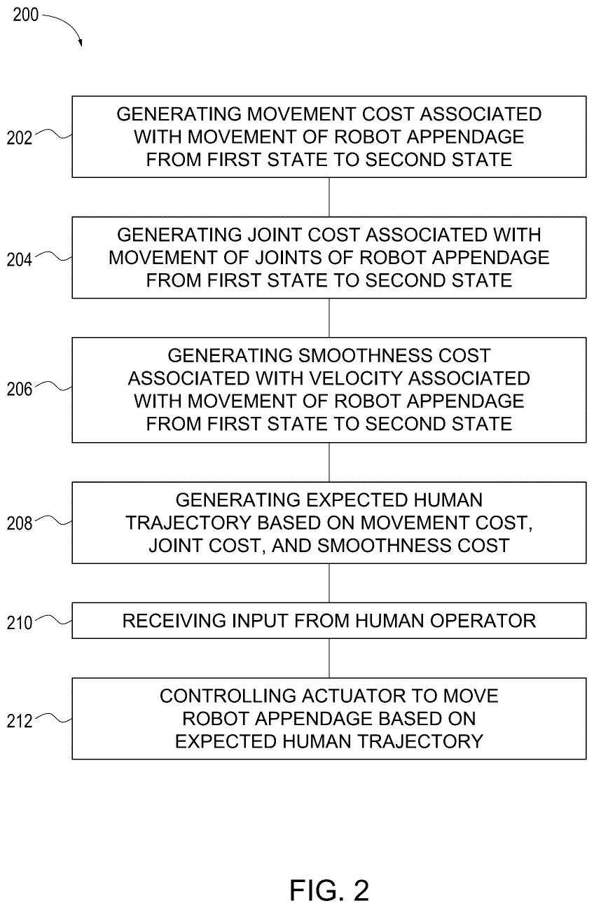

FIG. 2 is an exemplary computer-implemented method 200 for expected human trajectory generation for teleoperation, according to one aspect. The computer-implemented method 200 for expected human trajectory generation for teleoperation may include generating 202 a movement cost associated with movement of a robot appendage 132 from a first state including a start position and a start pose to a second state including a goal position and a goal pose, generating 204 a joint cost associated with movement of joints of the robot appendage 132 from the first state to the second state, generating 206 a smoothness cost associated with a velocity associated with movement of the robot appendage 132 from the first state to the second state, generating 208 an expected human trajectory based on the movement cost, the joint cost, and the smoothness cost, receiving 210 an input from a human operator, and controlling 212 an actuator 134 to move the robot appendage 132 based on the expected human trajectory and the input from the human operator or controlling the actuator 134 to move the robot appendage 132 based on minimizing an offset between the expected human trajectory and a trajectory associated with the input from the human operator.

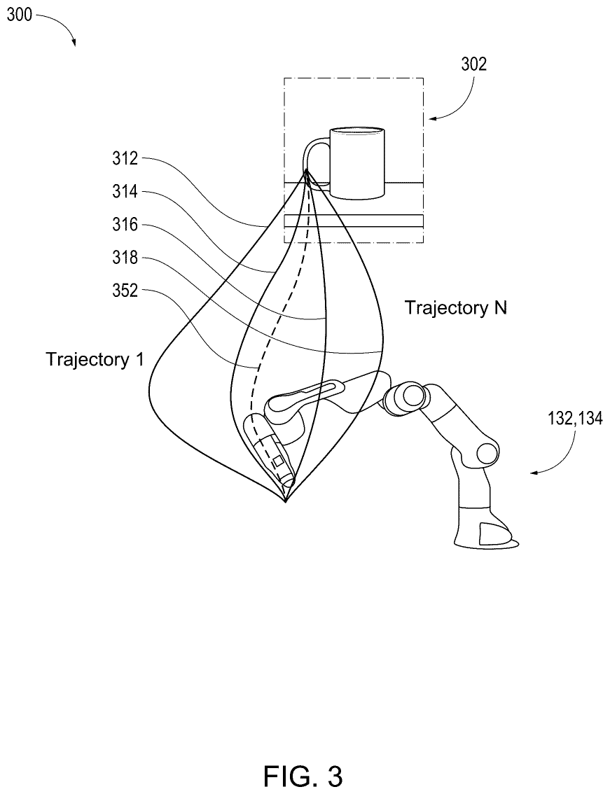

FIG. 3 is an exemplary scenario 300 where an expected human trajectory associated with teleoperation is generated according to the system and method for expected human trajectory generation for teleoperation of FIGS. 1-2, according to one aspect. In FIG. 3, the robot appendage 132 and actuator 134 (e.g., at a first state) have a target state (e.g., a second state) near an object 302 associated with a goal position and a goal pose. The robot or the system 100 for expected human trajectory generation for teleoperation may plan multiple feasible trajectories towards the goal pose. It may be seen that there are multiple trajectories 312, 314, 316, 318 available for the robot appendage 132 and actuator 134 to transition from the first state to the second state. Based on generating a movement cost, a joint cost, a smoothness cost, etc., an expected human trajectory 352 may be generated. In this way, a most similar trajectory (e.g., trajectory 314) may be selected for utilization based on minimum deviation from the expected human trajectory 352, for example. Explained yet another way, capturing the expectation of a human as a predicted trajectory may help the robot or the system 100 for expected human trajectory generation for teleoperation adapt to the human's expectation with minimum discrepancy, thereby ensuring SoA.

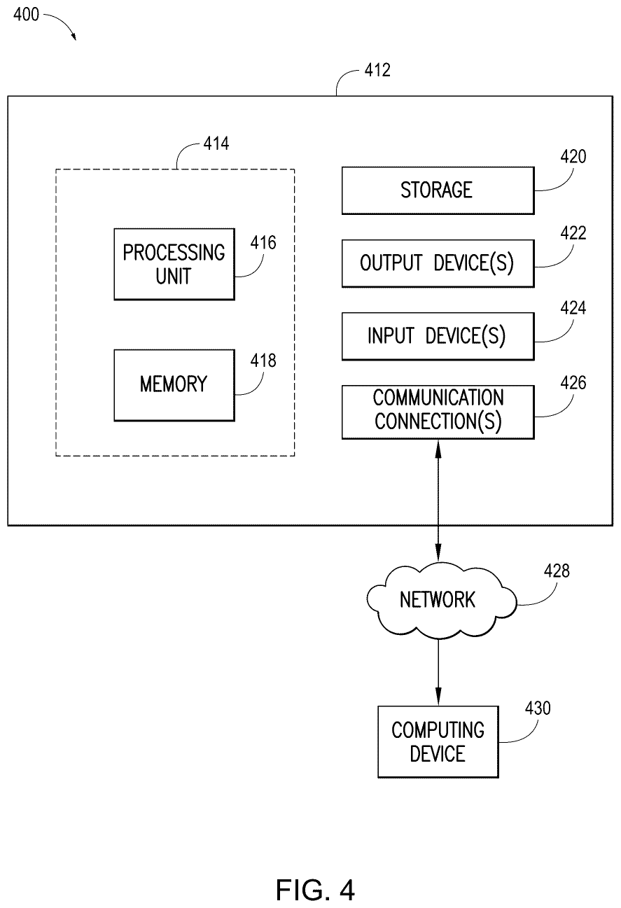

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

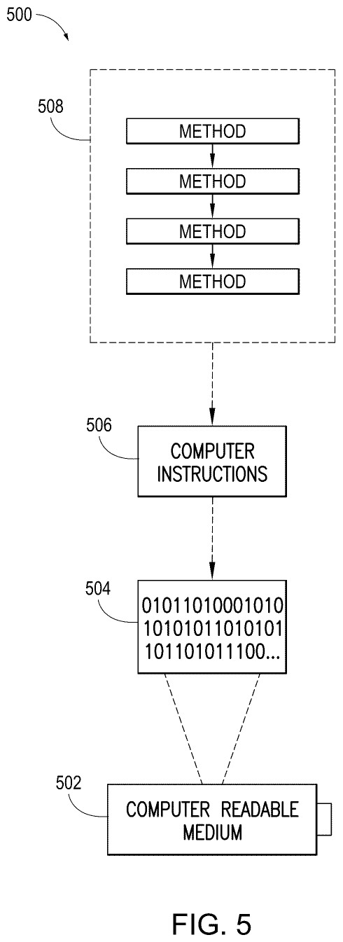

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 200 for expected human trajectory generation for teleoperation of FIG. 2. In another aspect, the processor-executable computer instructions 506 may be configured to implement a system, such as the system 100 for expected human trajectory generation for teleoperation of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for expected human trajectory generation for teleoperation, comprising:
a memory storing one or more instructions; and
a processor executing one or more of the instructions stored on the memory to perform:
generating a movement cost associated with movement of a robot appendage from a first state including a start position and a start pose to a second state including a goal position and a goal pose;
generating a joint cost associated with movement of joints of the robot appendage from the first state to the second state;
generating a smoothness cost associated with a velocity associated with movement of the robot appendage from the first state to the second state; and
generating an expected human trajectory based on the movement cost, the joint cost, and the smoothness cost.

2. The system for expected human trajectory generation for teleoperation of claim 1, comprising:
a control interface receiving an input from a human operator;
a controller; and
an actuator,
wherein the controller controls the actuator to move the robot appendage based on the expected human trajectory and the input from the human operator.

3. The system for expected human trajectory generation for teleoperation of claim 2, wherein the controller controls the actuator to move the robot appendage based on minimizing an offset between the expected human trajectory and a trajectory associated with the input from the human operator.

4. The system for expected human trajectory generation for teleoperation of claim 1, wherein the movement cost, the joint cost, and the smoothness cost are generated without using sensor feedback information from sensors associated with the robot appendage.

5. The system for expected human trajectory generation for teleoperation of claim 1, wherein the movement cost, the joint cost, and the smoothness cost are generated without using information indicative of a task or context associated with the first state, the start position, the start pose, the second state, the goal position, and the goal pose.

6. The system for expected human trajectory generation for teleoperation of claim 1, wherein the movement cost or the joint cost is generated based on a human arm skeletal model.

7. The system for expected human trajectory generation for teleoperation of claim 6, wherein the human arm skeletal model has seven degrees of freedom (DoF).

8. The system for expected human trajectory generation for teleoperation of claim 1, wherein the processor generates a jerk cost associated with an acceleration associated with movement of the robot appendage from the first state to the second state.

9. The system for expected human trajectory generation for teleoperation of claim 8, wherein the processor generates the expected human trajectory based on the jerk cost.

10. The system for expected human trajectory generation for teleoperation of claim 1, wherein the processor generates the expected human trajectory based on model predictive control (MPC).

11. A computer-implemented method for expected human trajectory generation for teleoperation, comprising:
generating a movement cost associated with movement of a robot appendage from a first state including a start position and a start pose to a second state including a goal position and a goal pose;
generating a joint cost associated with movement of joints of the robot appendage from the first state to the second state;
generating a smoothness cost associated with a velocity associated with movement of the robot appendage from the first state to the second state; and
generating an expected human trajectory based on the movement cost, the joint cost, and the smoothness cost.

12. The computer-implemented method for expected human trajectory generation for teleoperation of claim 11, comprising:
receiving an input from a human operator; and
controlling an actuator to move the robot appendage based on the expected human trajectory and the input from the human operator.

13. The computer-implemented method for expected human trajectory generation for teleoperation of claim 12, comprising controlling the actuator to move the robot appendage based on minimizing an offset between the expected human trajectory and a trajectory associated with the input from the human operator.

14. The computer-implemented method for expected human trajectory generation for teleoperation of claim 11, wherein the movement cost, the joint cost, and the smoothness cost are generated without using sensor feedback information from sensors associated with the robot appendage.

15. The computer-implemented method for expected human trajectory generation for teleoperation of claim 11, wherein the movement cost, the joint cost, and the smoothness cost are generated without using information indicative of a task or context associated with the first state, the start position, the start pose, the second state, the goal position, and the goal pose.

16. A system for expected human trajectory generation for teleoperation, comprising:
a control interface receiving an input from a human operator;
an actuator;
a memory storing one or more instructions;
a processor executing one or more of the instructions stored on the memory to perform:
generating a movement cost associated with movement of a robot appendage from a first state including a start position and a start pose to a second state including a goal position and a goal pose;
generating a joint cost associated with movement of joints of the robot appendage from the first state to the second state;
generating a smoothness cost associated with a velocity associated with movement of the robot appendage from the first state to the second state; and
generating an expected human trajectory based on the movement cost, the joint cost, and the smoothness cost; and
a controller controlling the actuator to move the robot appendage based on the expected human trajectory and the input from the human operator.

17. The system for expected human trajectory generation for teleoperation of claim 16, wherein the controller controls the actuator to move the robot appendage based on minimizing an offset between the expected human trajectory and a trajectory associated with the input from the human operator.

18. The system for expected human trajectory generation for teleoperation of claim 17, wherein the movement cost, the joint cost, and the smoothness cost are generated without using sensor feedback information from sensors associated with the robot appendage.

19. The system for expected human trajectory generation for teleoperation of claim 16, wherein the movement cost, the joint cost, and the smoothness cost are generated without using information indicative of a task or context associated with the first state, the start position, the start pose, the second state, the goal position, and the goal pose.

20. The system for expected human trajectory generation for teleoperation of claim 16, wherein the movement cost or the joint cost is generated based on a human arm skeletal model.
